(19) United States
(12) Patent Application Publication
(10) Pub. No.: US 2026/0220513 A1
(43) Pub. Date: Jul. 30, 2026

(54) HIGH-FIDELITY STATE DEPENDENT KICKS FOR FAST MULTI-QUBIT GATES IN ION TRAPS

(71) Applicants: lonQ, Inc., College Park, MD (US); IonQ Quantum Canada, Inc., Toronto (CA)

(72) Inventors: Varun Dilip VAIDYA, Toronto (CA); Cesar Ricardo VITERI, Cary, NC (US); Haonan LIU, Parker, CO (US); Jonathan Albert MIZRAHI, Silver Spring, MD (US)

(21) Appl. No.: 19/242,850

(22) Filed: Jun. 18, 2025

Related U.S. Application Data
(60) Provisional application No. 63/751,796, filed on Jan. 30, 2025.

(51) Int. Cl. G06N 10/40

(52) U.S. Cl. CPC G06N 10/40

(57) ABSTRACT

A system and method is provided for generating optical waveforms for driving high-fidelity state-dependent kicks (SDKs) in trapped ions. An exemplary method includes implementing a clock to synchronize at least one beam across a modulation hardware component, a pulse-picking hardware component, and a direction control hardware component; generating the at least one beam using a laser; inputting the at least one beam into at least one modulator to generate an SDK pulse-shaped waveform, wherein the at least one modulator is driven by the clock; and performing a pulse-picking and a direction control of the SDK pulse-shaped waveform to control a timing and a direction of the SDK pulse-shaped waveform in accordance with the clock for applying the SDK pulse-shaped waveform to a first trapped ion in an ion trap.

### CROSS REFERENCE TO RELATED APPLICATIONS

This application claims priority to U.S. Patent Provisional Application No. 63/751,796, filed Jan. 30, 2025, the entire contents of which are hereby incorporated by reference.

### TECHNICAL FIELD

Aspects of the present disclosure relate generally to systems and methods for use in the implementation, and/or operation of quantum information processing (QIP) systems.

### BACKGROUND

Trapped atoms are one of the leading implementations for quantum information processing or quantum computing. Other implementations include those based on superconducting qubits or photonic qubits, for example. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

It is therefore important to develop new techniques that improve the design, fabrication, implementation, control, and/or functionality of different quantum information processing (QIP) systems used as quantum computers or quantum simulators, and particularly for those QIP systems that handle operations based on atomic-based qubits.

### SUMMARY

The following presents a simplified summary of one or more aspects to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

The present disclosure describes various aspects of methods and systems that implement a framework for generating optical waveforms for driving high-fidelity state-dependent kicks (SDKs) in trapped ions. To overcome the limitations of time-domain multiplexing, the present disclosure describes using lasers (e.g., a high-repetition pulsed laser or a continuous wave (CW) laser) to allow for amplitude, phase, and/or in-phase and quadrature (IQ) modulation of every individual pulse supplied by the laser.

In one exemplary aspect, a method for generating optical waveforms for driving high-fidelity SDKs in trapped ions. The method includes: implementing a clock to synchronize at least one beam across a modulation stage, a pulse-picking stage, and a direction control stage; generating the at least one beam using a laser; inputting the at least one beam into at least one modulator to generate an SDK pulse-shaped waveform, wherein the at least one modulator is driven by the clock; and performing a pulse-picking and a direction control of the SDK pulse-shaped waveform to control a timing and a direction of the SDK pulse-shaped waveform in accordance with the clock for applying the SDK pulse-shaped waveform to a first trapped ion in an ion trap.

In some aspects, the techniques described herein relate to a method, wherein the at least one beam corresponds to a pulse train generated by a high-repetition rate pulsed laser.

In some aspects, the techniques described herein relate to a method, wherein the high-repetition pulsed laser corresponds to: a near infrared laser (NIR), a harmonically mode-locked laser, and soliton microcombs.

In some aspects, the techniques described herein relate to a method, further comprising: generating two CW beams using a CW laser, wherein the two CW beams have frequencies separated by a qubit frequency and an offset.

In some aspects, the techniques described herein relate to a method, wherein the at least one modulator corresponds to an amplitude modulator (AM).

In some aspects, the techniques described herein relate to a method, wherein the at least one modulator corresponds to a frequency modulator (FM).

In some aspects, the techniques described herein relate to a method, wherein the at least one modulator corresponds to a phase modulator (PM).

In some aspects, the techniques described herein relate to a method, wherein the at least one modulator corresponds to an (IQ) modulator.

In some aspects, the techniques described herein relate to a method, further comprising: modifying an optical power of the SDK pulse-shaped waveform for applying the SDK pulse-shaped waveform to apply fast gates on the ions.

In some aspects, the techniques described herein relate to a method, further comprising: converting a wavelength of the SDK pulse-shaped waveform to a visible wavelength.

According to one aspect of the disclosure, a quantum information processing (QIP) system is provided for generating optical waveforms for driving high-fidelity SDKs in trapped ions, the system including: an array of trapped ions including a first trapped ion; an optical system configured to generate at least one beam; an ion trap configured to trap the first trapped ion, a trapping potential of the ion trap being switchable between a first trapping potential and a second trapping potential; and a controller configured to control operations of the optical system and the ion trap including: implementing a clock to synchronize at least one beam across a modulation stage, a pulse-picking stage, and a direction control stage; causing the optical system to generate the at least one beam; inputting the at least one beam into at least one modulator to generate an SDK pulse-shaped waveform, wherein the at least one modulator is driven by the clock; and performing a pulse-picking and a direction control of the SDK pulse-shaped waveform to control a timing and a direction of the SDK pulse-shaped waveform in accordance with the clock for applying the SDK pulse-shaped waveform to the first trapped ion in an ion trap.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a view of atomic ions in a linear crystal or chain in accordance with aspects of this disclosure.

FIG. 2 illustrates an example of a quantum information processing (QIP) system in accordance with aspects of this disclosure.

FIG. 3 illustrates an example of a computer device in accordance with aspects of this disclosure.

FIG. 4A illustrates a first example of generating optical waveforms for driving high fidelity state-dependent kicks (SDKs) in trapped ions using a high-repetition rate pulsed laser in accordance with aspects of this disclosure.

FIG. 4B illustrates a second example of generating optical waveforms for driving high fidelity SDKs in trapped ions using a high-repetition rate pulsed laser in accordance with aspects of this disclosure.

FIG. 5A illustrates a first example of generating optical waveforms for driving high fidelity SDKs in trapped ions using a continuous wave (CW) laser in accordance with aspects of this disclosure.

FIG. 5B illustrates a second example of generating optical waveforms for driving high fidelity SDKs in trapped ions using a CW laser in accordance with aspects of this disclosure.

FIG. 6 illustrates an example of a method for generating optical waveforms for driving high-fidelity SDKs in trapped ions in accordance with aspects of this disclosure.

FIG. 7 shows an exemplary QIP system according to an embodiment of the present disclosure.

Like reference numbers and designations in the various drawings indicate like elements.

### DETAILED DESCRIPTION

The detailed description set forth below in connection with the appended drawings or figures is intended as a description of various configurations or implementations and is not intended to represent the only configurations or implementations in which the concepts described herein may be practiced. The detailed description includes specific details for the purpose of providing a thorough understanding of various concepts. However, it will be apparent to those skilled in the art that these concepts may be practiced without these specific details or with variations of these specific details. In some instances, well known components are shown in block diagram form, while some blocks may be representative of one or more well-known components.

Trapped-ion systems are renowned for their high-fidelity qubits, which are ideal for quantum computation due to their strong isolation from environmental noise and precise controllability. However, a key challenge in these systems lies in the relatively slow implementation of multi-qubit gates, which are essential for creating entanglement —a foundational resource for quantum algorithms. Multi-qubit gates in trapped ions rely on exciting the collective motion of the ions and carefully controlling state-dependent interactions.

For example, the Molmer-Sorensen and Light Shift gate schemes use weak, continuous, state-dependent forces applied via laser fields to excite the ions' vibrational modes. To ensure that the motion of the ions is restored after gate operation, these schemes (e.g., Molmer-Sorensen and Light Shift gate schemes) drive the qubit with long, weak optical pulses capable of resolving the motional sidebands of the ions. However, this process is inherently slow because it requires finely tuned laser or microwave parameters to ensure precision while minimizing errors such as heating or decoherence. The weak forces, while necessary for maintaining high fidelity, also limit the speed at which the gates can be performed. These constraints make multi-qubit gate operations significantly slower than single-qubit gates, presenting a bottleneck for the performance of trapped-ion quantum computers. In addition, multi-qubit gates using these schemes leave the gate fidelity susceptible to low-frequency environmental noise.

In some embodiments, fast (e.g., non-adiabatic) multi-qubit gates may be implemented by imparting a series of impulsive SDKs on nanosecond timescales, instead of a continuous force. These types of gates build mechanical energy much faster than motional frequencies and complete a two-qubit gate on microseconds timescales. However, the fidelity of non-adiabatic gates is fundamentally limited by the ability to optically impart a clean SDK to an ion.

In other embodiments, a non-adiabatic gate may be implemented between hyperfine Yb⁺ qubits, but its fidelity may be limited to 76% by the quality of the underlying SDKs. The dominant source of error in these implementations was multi-photon kicks, where an SDK pulse had a small but finite probability to apply a kick of multiple photon momenta. Suppressing this effect is important to improving the fidelity of an SDK and consequently a fast multi-qubit gate in trapped ions.

In addition, other embodiments describe schemes that rely on time-domain multiplexing to generate SDK waveforms. The target waveform was generated by splitting and recombining a low repetition rate pulsed laser through a series of optical delay lines. However, a limitation of this approach is the inability to modulate pulse amplitude and phases, which are controls needed to suppress multi-photon kicks. On top of the unwanted backward kicks, these embodiments may generate multiple kicks. For example, if the qubit state begins at zero and there is one kick then the qubit state may go to some momentum P. However, there is a probability that there can be two kicks and go to 2P and 3P and so forth. In this way, the modulated phase amplitude and phases may suppress the higher order kicks as well. Furthermore, optical delay lines occupy a large opto-mechanical footprint and provide a very limited tuning range for optimization of SDK waveforms.

The present disclosure proposes an approach to generating optical waveforms designed specifically for driving SDKs operations in trapped ion systems. By addressing the challenges of time-domain multiplexing, the invention employs a high-repetition rate pulsed laser or continuous wave laser in conjunction with at least one modulator. These modulators enable precise control over the amplitude, phase, and/or in-phase quadrature (IQ) components of each individual laser pulse, offering flexibility and granularity. This method not only enhances the precision of waveform generation, but also supports tailored pulse shaping to optimize ion qubit interactions, reducing errors and improving gate fidelity in quantum computing applications.

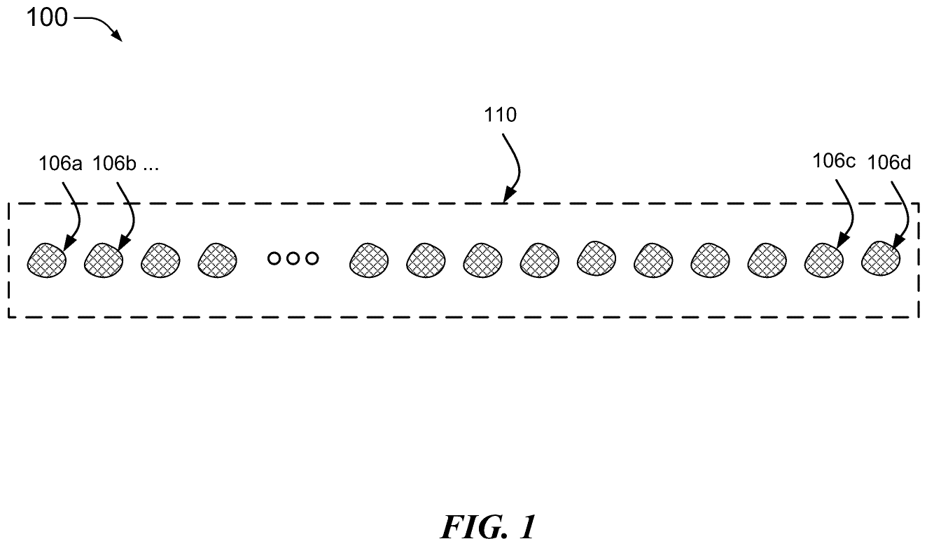

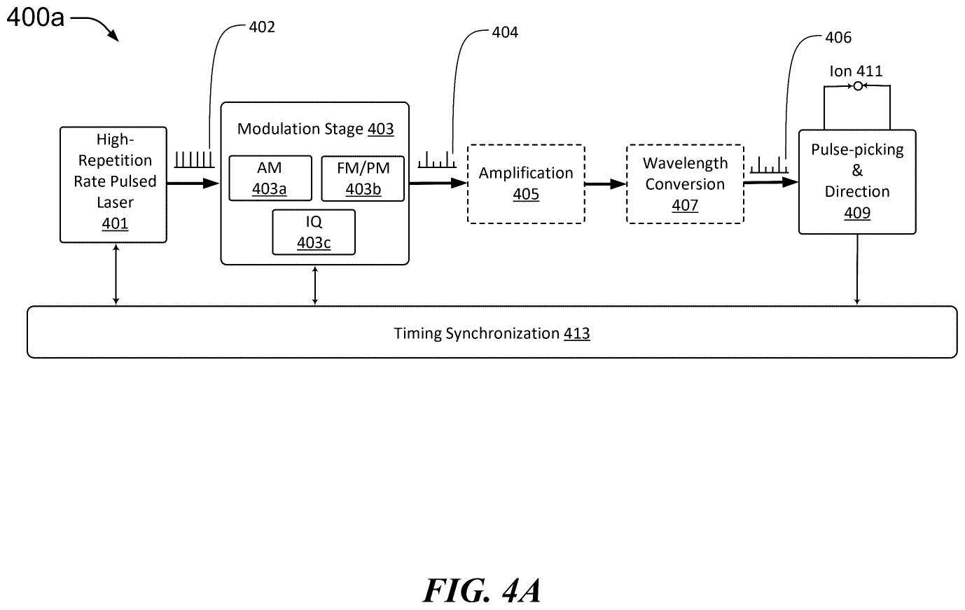

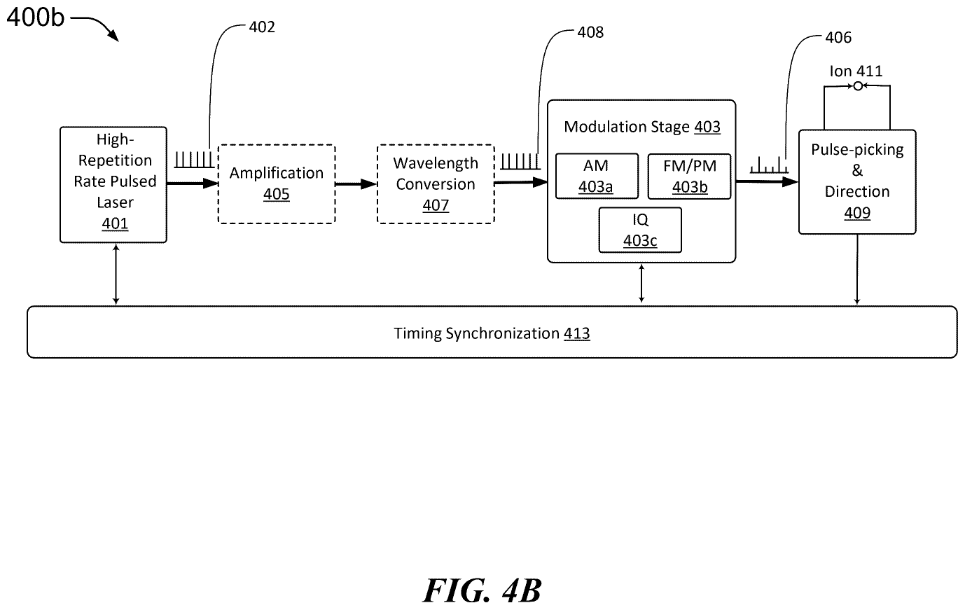

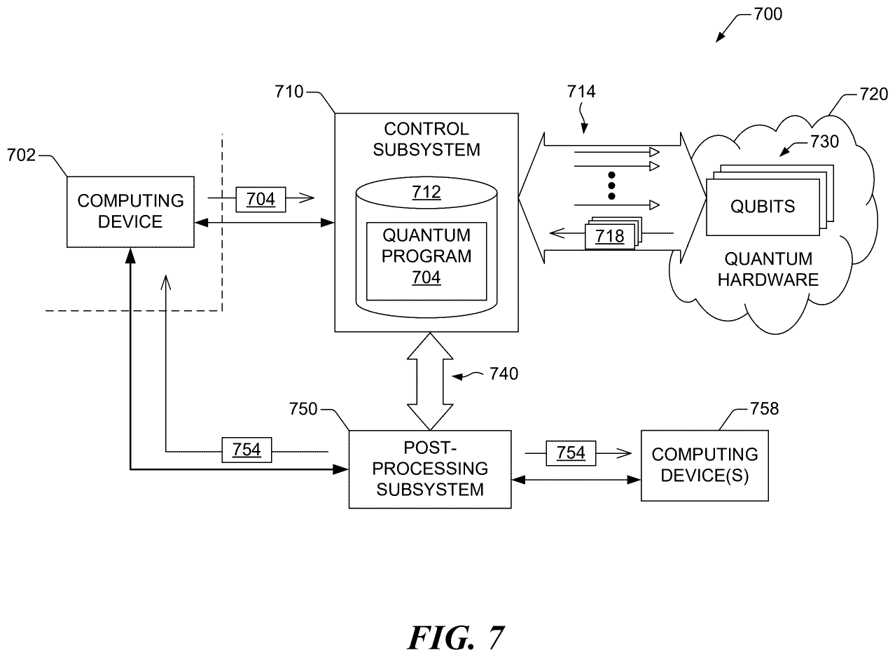

Solutions to the issues described above are explained in more detail in connection with FIGS. 1-7, with FIGS. 1-3 and FIG. 7 providing a general disclosure of QIP systems or quantum computers, and more specifically, of atomic based QIP systems or quantum computers, FIGS. 4-6 provide descriptions and examples of generating optical waveforms for driving high-fidelity SDKs in trapped ions in accordance with various example aspects of the present disclosure. In addition, FIG. 7 illustrating a QIP system on which aspects of systems and methods for generating optical waveforms for driving high-fidelity SDKs in trapped ions according to aspects of the present disclosure.

Trapped atoms are one of the leading implementations for quantum information processing or quantum computing. Atomic-based qubits may be used as quantum memories, as quantum gates in quantum computers and simulators, and may act as nodes for quantum communication networks. Qubits based on trapped atomic ions enjoy a rare combination of attributes. For example, qubits based on trapped atomic ions have very good coherence properties, may be prepared and measured with nearly 100% efficiency, and are readily entangled with each other by modulating their Coulomb interaction with suitable external control fields such as optical or microwave fields. These attributes make atomic-based qubits attractive for extended quantum operations such as quantum computations or quantum simulations.

Atomic quantum computers can include array(s) of atoms or ions trapped, for example, inside a vacuum chamber. A size and dimensionality of atomic arrays may vary.

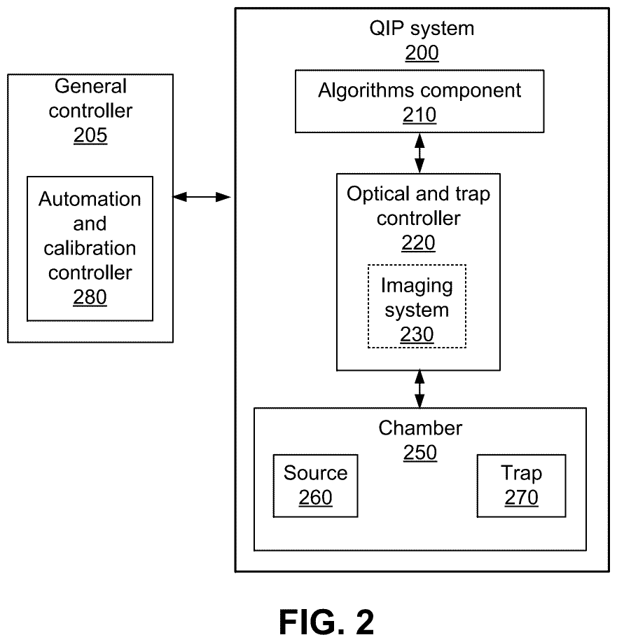

FIG. 1 illustrates a diagram 100 with multiple atomic ions or ions 106 (e.g., ions 106a, 106b, . . . , 106c, and 106d) trapped in a linear crystal or chain 110 using a trap (not shown; the trap can be inside a vacuum chamber as shown in FIG. 2). The trap maybe referred to as an ion trap. The ion trap shown may be built or fabricated on a semiconductor substrate, a dielectric substrate, or a glass die or wafer (also referred to as a glass substrate). The ions 106 may be provided to the trap as atomic species for ionization and confinement into the chain 110. Some or all of the ions 106 may be configured to operate as qubits in a QIP system.

In the example shown in FIG. 1, the trap includes electrodes for trapping or confining multiple ions into the chain 110 laser-cooled to be nearly at rest. The number of ions trapped can be configurable and more or fewer ions may be trapped. The ions can be ytterbium ions (e.g., ¹⁷¹Yb⁺ ions), for example. The ions are illuminated with laser (optical) radiation tuned to a resonance in ¹⁷¹Yb⁺ and the fluorescence of the ions is imaged onto a camera or some other type of detection device (e.g., photomultiplier tube or PMT). In this example, ions may be separated by a few microns (μm) from each other, although the separation may vary based on architectural configuration. The separation of the ions is determined by a balance between the external confinement force and Coulomb repulsion and does not need to be uniform. Moreover, in addition to ytterbium ions, barium ions, neutral atoms, Rydberg atoms, or other types of atomic-based qubit technologies may also be used. Moreover, ions of the same species, ions of different species, and/or different isotopes of ions may be used. The trap may be a linear RF Paul trap, but other types of confinement devices may also be used, including optical confinements. Thus, a confinement device may be based on different techniques and may hold ions, neutral atoms, or Rydberg atoms, for example, with an ion trap being one example of such a confinement device. The ion trap may be a surface trap, for example.

The chain 110 of ions 106 may be part of a QPU, that is, the chain 110 of ions 106 may be part of a processing engine or processing core of a QIP system. When any one of the ions 106 is capable of being connected to any other ion 106 in the chain 110, the chain 110 is considered to be fully connected, and thus, it can be used to implement a fully connected QPU. Fully connected QPUs need not be limited to atomic-based QIP systems.

FIG. 2 illustrates a block diagram that shows an example of a QIP system 200. The QIP system 200 may also be referred to as a quantum computing system, a quantum computer, a computer device, a trapped ion system, or the like. The QIP system 200 may be part of a hybrid computing system in which the QIP system 200 is used to perform quantum computations and operations, and the hybrid computing system also includes a classical computer to perform classical computations and operations. The quantum and classical computations and operations may interact in such a hybrid system.

Shown in FIG. 2 is a general controller 205 configured to perform various control operations of the QIP system 200. These control operations may be performed by an operator, may be automated, or a combination of both. Instructions for at least some of the control operations may be stored in memory (not shown) in the general controller 205 and may be updated over time through a communications interface (not shown). Although the general controller 205 is shown separate from the QIP system 200, the general controller 205 may be integrated with or be part of the QIP system 200. The general controller 205 may include an automation and calibration controller 280 configured to perform various calibration, testing, and automation operations associated with the QIP system 200. These calibration, testing, and automation operations may involve, for example, all or part of an algorithms component 210, all or part of an optical and trap controller 220 and/or all or part of a chamber 250.

The QIP system 200 may include the algorithms component 210 mentioned above, which may operate with other parts of the QIP system 200 to perform or implement quantum algorithms, quantum applications, or quantum operations. The algorithms component 210 may be used to perform or implement a stack or sequence of combinations of single qubit operations and/or multi-qubit operations (e.g., two-qubit operations) as well as extended quantum computations. The algorithms component 210 may also include software tools (e.g., compilers) that facility such performance or implementation. As such, the algorithms component 210 may provide, directly or indirectly, instructions to various components of the QIP system 200 (e.g., to the optical and trap controller 220) to enable the performance or implementation of the quantum algorithms, quantum applications, or quantum operations. The algorithms component 210 may receive information resulting from the performance or implementation of the quantum algorithms, quantum applications, or quantum operations and may process the information and/or transfer the information to another component of the QIP system 200 or to another device (e.g., an external device connected to the QIP system 200) for further processing.

The QIP system 200 may include the optical and trap controller 220 mentioned above, which controls various aspects of a trap 270 in the chamber 250, including the generation of signals to control the trap 270. The optical and trap controller 220 may also control the operation of lasers, optical systems, and optical components that are used to provide the optical beams that interact with the atoms or ions in the trap. Optical systems that include multiple components may be referred to as optical assemblies. The optical beams are used to set up the ions, to perform or implement quantum algorithms, quantum applications, or quantum operations with the ions, and to read results from the ions. Control of the operations of laser, optical systems, and optical components may include dynamically changing operational parameters and/or configurations, including controlling positioning using motorized mounts or holders. When used to confine or trap ions, the trap 270 may be referred to as an ion trap. The trap 270, however, may also be used to trap neutral atoms, Rydberg atoms, and other types of atomic-based qubits. The lasers, optical systems, and optical components can be at least partially located in the optical and trap controller 220, an imaging system 230, and/or in the chamber 250.

The QIP system 200 may include the imaging system 230. The imaging system 230 may include a high-resolution imager (e.g., Charge-Coupled Device (CCD) camera) or other type of detection device (e.g., Photomultiplier Tube (PMT)) for monitoring the ions while they are being provided to the trap 270 and/or after they have been provided to the trap 270 (e.g., to read results). In an aspect, the imaging system 230 can be implemented separate from the optical and trap controller 220, however, the use of fluorescence to detect, identify, and label ions using image processing algorithms may need to be coordinated with the optical and trap controller 220.

In addition to the components described above, the QIP system 200 can include a source 260 that provides atomic species (e.g., a plume or flux of neutral atoms) to the chamber 250 having the trap 270. When atomic ions are the basis of the quantum operations, that trap 270 confines the atomic species once ionized (e.g., photoionized). The trap 270 may be part of what may be referred to as a processor or processing portion of the QIP system 200. That is, the trap 270 may be considered at the core of the processing operations of the QIP system 200 since it holds the atomic-based qubits that are used to perform or implement the quantum operations or simulations. At least a portion of the source 260 may be implemented separate from the chamber 250.

It is to be understood that the various components of the QIP system 200 described in FIG. 2 are described at a high-level for ease of understanding. Such components may include one or more sub-components, the details of which may be provided below as needed to better understand certain aspects of this disclosure.

Aspects of this disclosure may be implemented at least partially using one or more of the general controller 205, the automation and calibration controller 280, the optical and trap controller 220, and the chamber 250.

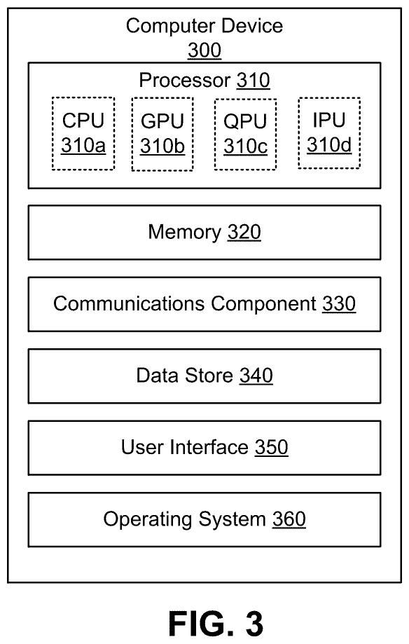

Referring now to FIG. 3, an example of a computer system or device 300 is shown. The computer device 300 may represent a single computing device, multiple computing devices, or a distributed computing system, for example. The computer device 300 may be configured as a quantum computer (e.g., a QIP system), a classical computer, or to perform a combination of quantum and classical computing functions, sometimes referred to as hybrid functions or operations. For example, the computer device 300 may be used to process information using quantum algorithms, classical computer data processing operations, or a combination of both. In some instances, results from one set of operations (e.g., quantum algorithms) are shared with another set of operations (e.g., classical computer data processing). A generic example of the computer device 300 implemented as a QIP system configured to perform quantum computations and simulations is, for example, the QIP system 200 shown in FIG. 2.

The computer device 300 may include a processor 310 for carrying out processing functions associated with one or more of the features described herein. The processor 310 may include a single processor, multiple set of processors, or one or more multi-core processors. Moreover, the processor 310 may be implemented as an integrated processing system and/or a distributed processing system. The processor 310 may include one or more central processing units (CPUs) 310a, one or more graphics processing units (GPUs) 310b, one or more quantum processing units (QPUs) 310c, one or more intelligence processing units (IPUs) 310d (e.g., artificial intelligence or AI processors), or a combination of some or all those types of processors. In one aspect, the processor 310 may refer to a general processor of the computer device 300, which may also include additional processors 310 to perform more specific functions (e.g., including functions to control the operation of the computer device 300). Quantum operations may be performed by the QPUs 310c. Some or all of the QPUs 310c may use atomic-based qubits, however, it is possible that different QPUs are based on different qubit technologies. One or more of the QPUs 310c may be fully connected QPUs in accordance with aspects of this disclosure.

The computer device 300 may include a memory 320 for storing instructions executable by the processor 310 to carry out operations. The memory 320 may also store data for processing by the processor 310 and/or data resulting from processing by the processor 310. In an implementation, for example, the memory 320 may correspond to a computer-readable storage medium that stores code or instructions to perform one or more functions or operations. Just like the processor 310, the memory 320 may refer to a general memory of the computer device 300, which may also include additional memories 320 to store instructions and/or data for more specific functions.

It is to be understood that the processor 310 and the memory 320 may be used in connection with different operations including but not limited to computations, calculations, simulations, controls, calibrations, system management, and other operations of the computer device 300, including any methods or processes described herein.

Further, the computer device 300 may include a communications component 330 that provides for establishing and maintaining communications with one or more parties utilizing hardware, software, and services. The communications component 330 may also be used to carry communications between components on the computer device 300, as well as between the computer device 300 and external devices, such as devices located across a communications network and/or devices serially or locally connected to computer device 300. For example, the communications component 330 may include one or more buses, and may further include transmit chain components and receive chain components associated with a transmitter and receiver, respectively, operable for interfacing with external devices. The communications component 330 may be used to receive updated information for the operation or functionality of the computer device 300.

Additionally, the computer device 300 may include a data store 340, which can be any suitable combination of hardware and/or software, which provides for mass storage of information, databases, and programs employed in connection with the operation of the computer device 300 and/or any methods or processes described herein. For example, the data store 340 may be a data repository for operating system (OS) 360 (e.g., classical OS, or quantum OS, or both). In one implementation, the data store 340 may include the memory 320. In an implementation, the processor 310 may execute the operating system 360 and/or applications or programs, and the memory 320 or the data store 340 may store them.

The computer device 300 may also include a user interface component 350 configured to receive inputs from a user of the computer device 300 and further configured to generate outputs for presentation to the user or to provide to a different system (directly or indirectly). The user interface component 350 may include one or more input devices, including but not limited to a keyboard, a number pad, a mouse, a touch-sensitive display, a digitizer, a navigation key, a function key, a microphone, a voice recognition component, any other mechanism capable of receiving an input from a user, or any combination thereof. Further, the user interface component 350 may include one or more output devices, including but not limited to a display, a speaker, a haptic feedback mechanism, a printer, any other mechanism capable of presenting an output to a user, or any combination thereof. In an implementation, the user interface component 350 may transmit and/or receive messages corresponding to the operation of the operating system 360. When the computer device 300 is implemented as part of a cloud-based infrastructure solution, the user interface component 350 may be used to allow a user of the cloud-based infrastructure solution to remotely interact with the computer device 300.

The present disclosure may describe methods and systems implemented on ion traps in FIGS. 1-3 and 7 for illustrative purposes only, it should be noted that the methods and systems described in the present disclosure may be applied to other quantum computing technologies.

Generally, two-qubit gates in trapped ions are achieved by coupling the ions' internal states (such as their ‘spins’) to their collective motion. In some approaches, the ions are subtly manipulated within the ion trap. However, this method has a drawback: the gentle pushing and pulling of the ions means the gate operation takes a longer time to complete. Moreover, during this extended duration, environmental noise can impact the qubit states. Consequently, there is significant interest in speeding up this process.

Rather than relying on continuous, gentle forces to manipulate the ions, the present disclosure employs impulsive kicks. For instance, with two stationary ions, at time=0, the present disclosure applies pulses that instantaneously perturb the ions based on their qubit state. Afterward, the ions may evolve for a period of time before applying another kick to half their motion. By using these impulsive forces, the present disclosure completes the gate in a much shorter time, reducing its susceptibility to environmental noise.

Achieving a high-fidelity gate requires ensuring that each kick is applied with exceptional precision. If the qubit is in state zero, then a kick in a particular direction is applied. If the qubit is in state one, then a kick in the opposite direction is applied such that the goal is to do this in a deterministic manner.

As will be explained in more detail below, FIGS. 4-6 provide detailed examples of the implementation and operation of high-fidelity SDKs using photonic components to deliver tailored laser waveforms to the ions. While FIGS. 2 and 3 present the foundational architecture of the QIP system, including components such as the general controller, optical and trap controllers, and quantum processors, FIGS. 4-6 expand on the methodology for achieving precise multi-qubit gate operations essential for quantum computation. In other words, FIGS. 4-6 demonstrate how the system claims in FIGS. 2-3 and 7, focused on QIP architecture and functionality, may be realized through advanced laser-based control techniques.

FIG. 4A illustrates a first example of generating optical waveforms for driving high fidelity SDKs in trapped ions using a high-repetition rate pulsed laser in accordance with aspects of this disclosure. Specifically, FIG. 4A introduces the use of a high-repetition-rate pulsed laser, alongside a modulation stage, to generate SDK waveforms that facilitate fast and deterministic quantum gates.

To obtain a two-qubit gate with a high fidelity, multiple state-dependent kicks (SDKs) with a very high fidelity will need to be applied. Each SDK will kick the qubit in a direction depending on its state. For example, if the qubit is in state zero, the qubit will be kicked in one direction and if the qubit is in state one, then the qubit will be kicked in the opposite direction. These kicks should be performed deterministically. Accordingly, the example 400a describes designing optical pulse shapes that make sure each SDK is applied to impart momentum to the qubit in the correct direction, hence, provide a very high fidelity. In addition, the present disclosure describes designing the SDKs with the ability to control the individual amplitude of each pulse that comes out of the laser. Examples 400a and 400b illustrate the types of optical waveforms that will be produced at the output of the modulation stage 403.

Example 400a shows a high-repetition rate pulsed laser 401 that delivers a high repetition-rate optical pulse train 402 into a modulation stage 403. Specifically, the high-repetition rate pulsed laser 401 may be employed to generate a sequence of ultra-short optical pulses for driving Raman SDKs (RSDKs) at nanosecond or faster timescales in trapped ion qubits. These high-repetition rate pulses are critical for enabling fast, non-adiabatic two-qubit gate operations with microsecond or faster timing resolution.

In some aspects, the high-repetition rate pulsed laser 401 corresponds to a laser configured to operate in the near infrared (NIR) region of the electromagnetic spectrum, commonly around 780 to 2500 nanometers. This spectral range is advantageous due to its alignment with the low-loss transmission window of standard single-mode optical fibers, which enables efficient and stable delivery of optical signals over both short and long distances with minimal dispersion and attenuation. Additionally, this NIR wavelength range is well-supported by a mature ecosystem of commercially available optical components, including high-speed electro-optic modulators, isolators, filters, and photodetectors, largely developed for the telecommunications industry. Utilizing these well-established technologies allows for cost-effective system development, increased component reliability, and broader compatibility with integrated photonic platforms. In particular, operating at these NIR wavelengths enables the use of lithium niobate-based modulators, which offer high electro-optic coefficients and modulation bandwidths in excess of several gigahertz (GHz), making them well-suited for precise pulse shaping in high-repetition rate regimes. As described herein, the output of the NIR laser 401 may be further processed (e.g., amplified and frequency-converted via second harmonic generation) to produce visible wavelengths optimized for interaction with specific atomic transitions, such as those used in ion-based quantum systems.

In some aspects, the high-repetition rate pulsed laser 401 corresponds to a harmonically mode-locked laser (HMLL) configured to generate optical pulse trains at repetition rates in the GHz regime. The HMLL achieves such high repetition rates by phase-locking multiple longitudinal modes of a fiber ring cavity to harmonic frequencies of a reference clock signal, effectively modulating the round-trip gain of the cavity at an externally supplied microwave frequency. This synchronization is maintained through an active feedback loop incorporating a photodetector, phase-locked loop (PLL), and tunable delay line, which ensures that optical pulses circulate coherently within the cavity in phase with the drive signal. The gain medium within the HMLL may include a ytterbium-doped fiber (YDF) pumped by a CW diode laser, producing stable picosecond-scale pulses with narrow timing jitter. These pulse characteristics make the HMLL particularly well-suited for high-speed amplitude modulation and precise temporal control in optical systems that require per-pulse programmability. In the context of the present system, the HMLL serves as the foundational source of high-repetition rate NIR pulses, which are subsequently shaped, amplified, and frequency-converted to visible wavelengths for use in Raman-based quantum gate operations. Compared to traditional mode-locked lasers with lower repetition rates, the HMLL eliminates the need for time-domain multiplexing techniques and supports direct synchronization with high-speed digital control electronics, enabling precise implementation of RSDKs at nanosecond timescales with high fidelity and scalability.

As yet another example, the high-repetition rate pulsed laser 401 may correspond to a soliton microcomb, such as those generated using chip-scale optical microresonators. Soliton microcombs produce a train of ultrashort optical pulses by exploiting Kerr nonlinearity within a high-quality-factor (Q) microresonator, such as a silica, silicon nitride, or lithium niobate ring resonator. When pumped with a CW laser at sufficient power levels, the Kerr nonlinearity induces modulation instability that leads to the formation of dissipative Kerr solitons—stable, localized temporal structures that circulate in the cavity. These solitons correspond in the frequency domain to a set of equally spaced, phase-coherent optical lines forming a frequency comb. The repetition rate of the pulse train is determined by the free spectral range (FSR) of the microresonator, which can reach tens to hundreds of gigahertz depending on the resonator geometry. These devices enable chip-scale integration, low power consumption, and compact packaging, making them attractive for scalable and deployable photonic systems. In the context of the present system, soliton microcombs can serve as a compact, high-stability source of high-repetition rate pulses suitable for precise temporal modulation and frequency conversion to visible wavelengths. Their intrinsic coherence and spectral purity make them ideal for quantum control tasks such as RSDKs, and their compatibility with existing silicon photonics platforms facilitates integration with on-chip modulators and control electronics. Thus, soliton microcombs present a compelling alternative to traditional mode-locked lasers in high-speed, precision quantum optical systems.

The use of any of these high-repetition pulsed laser types in the system provides a consistent stream of optical pulses at GHz-scale repetition frequencies, thereby eliminating the need for time-domain multiplexing techniques traditionally used with lower repetition rate sources. Similar embodiments often rely on time-division multiplexing and free-space optical delay lines to simulate higher pulse rates, which introduced significant complexity, alignment challenges, and limited pulse shaping flexibility. In contrast, the described architecture leverages inherently high-frequency pulsed operation to simplify system design and enhance performance. By generating pulses at uniform intervals without additional multiplexing hardware, the system achieves increased efficiency, reduced mechanical footprint, and lower susceptibility to alignment drift or optical path length errors. Furthermore, this architecture supports arbitrary pulse shaping via integrated high-bandwidth amplitude modulators, as well as fast pulse-picking and direction-switching mechanisms. These capabilities enable precise, deterministic control over both the temporal and spatial characteristics of the RSDKs, which is essential for realizing high-fidelity, non-adiabatic quantum logic gates in trapped ion systems.

In some aspects, the modulation stage is a key subsystem configured to manipulate the temporal and spectral properties of individual pulses within a high-repetition rate optical pulse train in order to generate precisely shaped RSDK waveforms. The modulation stage may include at least one, or a combination, of an AM 403a, a phase or frequency modulator (FM/PM) 403b, and/or an IQ modulator 403c. These modulators enable fine-grained pulse-to-pulse control of the optical field, allowing independent adjustment of amplitude, phase, and frequency for each pulse. Such granular control is essential for engineering tailored SDK pulse profiles that suppress undesired phenomena such as multi-photon diffraction and erroneous kick directions—both of which are known to degrade gate fidelity in non-adiabatic quantum operations. The modulation stage 403 is synchronized to an external reference clock or, in some configurations, to another optical source (e.g., a second laser) to ensure that modulation signals are phase-locked with respect to the laser pulse timing and the qubit frequency.

This timing coordination is crucial for coherent pulse shaping and ensures that SDK waveforms are correctly aligned with the temporal window in which the ion is receptive to the state-dependent interaction. Importantly, the modulated optical waveform preserves its engineered characteristics through subsequent amplification and wavelength conversion stages, enabling efficient transfer to visible wavelengths optimized for ion interaction (e.g., via second harmonic generation from the NIR). The integration of the modulation stage 403 upstream of these transformations ensures that pulse fidelity is maintained throughout the entire optical pipeline. As a result, the modulation stage 403 acts as the “control brain” of the system, enabling the synthesis of high-fidelity, custom-tailored SDKs necessary for executing fast, scalable, and error-resilient quantum gates.

In some aspects, the SDK pulse-shaped waveforms 404 are directed through an optional optical amplification stage 405 to increase the pulse energy to levels sufficient for implementing high-speed quantum gate operations on trapped ions. The amplification stage 405 ensures that the shaped pulses maintain their temporal and spectral fidelity while achieving the power levels necessary to impart strong state-dependent forces on the ions. Modulation of the pulses is performed upstream (typically at NIR wavelengths) where high-speed amplitude, phase, and IQ modulators are commercially available and well-characterized. Performing modulation in the NIR allows for precise pulse shaping using reliable components, which is not currently feasible at visible or ion-resonant wavelengths due to limitations in available modulator technologies.

IQ modulation is a technique where a baseband signal is divided into two components: an in-phase (I) component with a 0-degree phase offset and a quadrature (Q) component with a 90-degree phase offset. These components are then used together to modulate a carrier signal, encoding information through variations in both its amplitude and phase. This approach can allow the user to do both amplitude and phase modulation using a single device.

Following amplification, the waveform passes through an optional wavelength conversion stage 407, where the NIR pulses are converted to shorter wavelengths, such as green, using techniques such as second harmonic generation (SHG). This process doubles the optical frequency (e.g., halves the wavelength), producing a visible beam that is resonant or near-resonant with a specific transition in the target ion species. The resulting green light exhibits stronger coupling with the ions, enhancing the efficiency and fidelity of ion manipulation. Importantly, this architecture preserves the engineered pulse shape through amplification and frequency conversion, ensuring that the final physical SDK waveform 406 meets all operational requirements (e.g., wavelength, power, and temporal structure) for optimal interaction with the ion qubits.

A pulse-picking & direction stage 409 controls the timings and directions of the SDKs applied to the ion 411. In some aspects, the system includes a control mechanism configured to manage the application of SDKs during gate operations. This mechanism provides (1) temporal control, enabling selective timing of SDK application relative to the gate sequence, and (2) directional control, allowing the SDKs to be applied in either of two opposite directions as required. Both timing and directional control are essential for executing a complete and accurate gate operation, ensuring the correct evolution of the ion qubit states in accordance with the desired quantum logic protocol. By precisely selecting and directing specific pulses (e.g., forward or backward), this stage ensures that the SDKs are accurately aligned with the target ion 411 at the appropriate intervals, enabling precise control and manipulation required for the intended operations.

To ensure coherent and precise operation across the optical system, an electronic timing synchronization stage 413 is implemented to coordinate the activities of the modulation stage 403, the optional amplification stage 405, the wavelength conversion stage 407, and the pulse-picking and direction control stage 409. In exemplary embodiments, the high-repetition rate pulsed laser 401 generates a pulse train 402 with a fixed temporal spacing T between pulses. The modulation stage 403 must operate in strict synchrony with this pulse train, such that modulation signals are applied in alignment with the arrival of each optical pulse. This synchronization is especially important when shaping SDK waveforms that must be matched to specific points in the ion's motional cycle, which in turn is governed by the qubit transition frequency. The precise relationship between the laser pulse period T and the qubit frequency requires phase-locked operation between the laser and modulation electronics.

Furthermore, the pulse-picking stage 409 must also be synchronized with the modulation stage 403 to ensure that only complete, correctly modulated SDK waveforms are selected and directed to the ion. Selecting a partial or misaligned pulse could result in incomplete or erroneous SDK application, degrading gate fidelity. Accordingly, all relevant system clocks—including those governing modulation, pulse-picking, and direction control—are phase-locked to a common reference clock or harmonically related frequencies. This unified synchronization framework ensures that all SDK-related optical components operate in concert, preserving waveform integrity and timing precision throughout the system. Without such synchronization, there would be a significant risk of misapplying SDKs, such as picking mid-waveform, leading to degraded performance and inconsistent gate outcomes.

FIG. 4B illustrates a second example of generating optical waveforms for driving high fidelity SDKs in trapped ions using a high-repetition rate pulsed laser in accordance with aspects of this disclosure. In contrast to example 400a of FIG. 4A, example 400b of FIG. 4B describes the modulation stage 403 occurring after the wavelength conversion stage 407.

Sending laser pulses with irregular time patterns to the amplification stage 405 and wavelength conversion 407 introduces context dependencies and inefficient non-linearities that add noise to the output pulse shapes 404 (as shown in FIG. 4A). These effects can be precompensated but not fully removed. Placing the modulation stage 403 after the wavelength conversion 407 offers the benefit of sending laser pulses with a periodic time pattern to 405 and 407. This allows the amplification stage and wavelength conversion to operate in steady-state without needing to do any precompensation.

The disclosed system provides a high-performance architecture for generating and applying high-fidelity SDKs in trapped-ion quantum systems by leveraging a high-repetition rate pulsed laser, integrated modulation, amplification, wavelength conversion, and synchronized pulse-picking. By enabling pulse-to-pulse amplitude, phase, and frequency control through high-bandwidth modulators (e.g., amplitude, phase, and IQ modulators) the system can suppress multi-photon diffraction and eliminate kicks in undesired directions, improving gate fidelity.

As shown in example 400a of FIG. 4A the modulation stage 403 is positioned upstream of wavelength conversion 407, operating initially in the NIR domain where telecom-grade modulators are readily available. This configuration supports precise pulse shaping and allows the subsequent amplification and frequency doubling (e.g., via second harmonic generation) to produce visible wavelengths that interact more effectively with trapped-ion qubits, such as those in barium ion systems.

Alternatively, as shown in example 400b of FIG. 4B, the modulation stage 403 is placed downstream of the wavelength conversion stage 407. This configuration preserves signal integrity by modulating a clean sequence of pulses 408, avoiding distortion introduced during amplification and conversion, which is especially useful when the amplification and conversion processes favor unmodulated input signals (e.g., the pulse train 402). It also enables greater flexibility in assigning wavelengths and modulation formats.

Both configurations are supported by a dedicated synchronization framework that ensures precise temporal alignment between the laser pulses, modulation, and SDK application, supporting sub-nanosecond timing precision essential for high-speed, non-adiabatic gate operations. Furthermore, the system includes a pulse-picking and direction control stage that deterministically applies SDKs at optimal times and in either forward or reverse directions, enabling accurate and symmetric momentum transfer to the ion. Collectively, these innovations enable fast, scalable, and error-resilient two-qubit gate operations, advancing the practical realization of high-fidelity trapped-ion quantum processors.

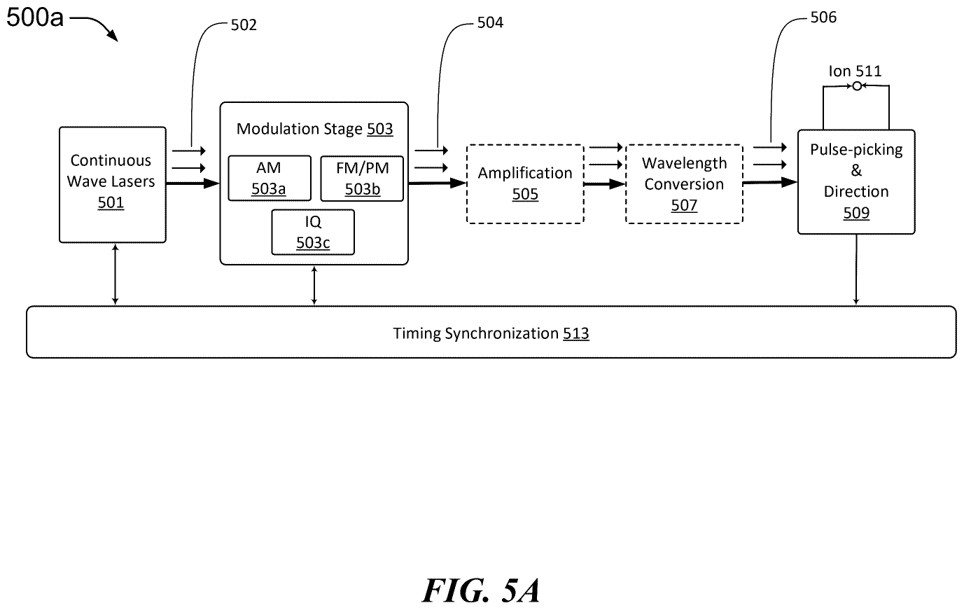

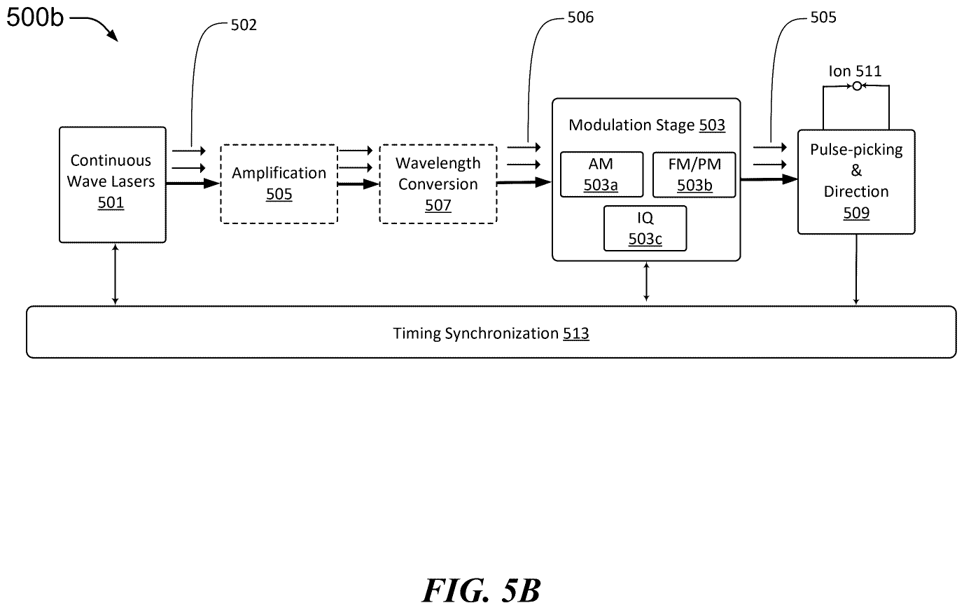

FIG. 5A illustrates a first example of generating optical waveforms for driving high fidelity SDKs in trapped ions using a CW laser in accordance with aspects of this disclosure. In contrast to example 400a of FIG. 4A showing a high-repetition rate pulsed laser 401, example 500a shows a CW laser 501 that delivers a two CW beam outputs 502 with frequencies separated by a qubit frequency and an offset. These two CW beam outputs 502 are directed into a modulation stage 503, where they undergo further processing.

Using a CW laser instead of a high-repetition rate pulsed laser for generating SDKs in trapped-ion quantum systems offers several advantages. CW lasers emit a continuous, monochromatic beam, eliminating the need for precise timing synchronization required in pulsed systems, where modulators and pulse pickers must operate in lockstep with each individual pulse. This simplification reduces system complexity and potential sources of error.

Additionally, the lower peak power of CW lasers decreases the likelihood of multi-photon diffraction events, a known source of gate infidelity in SDK implementations. Their stable, narrow-linewidth output also makes it easier to maintain the required frequency detuning between beams, which is crucial for high-fidelity two-qubit gates. This setup is designed to facilitate precise frequency modulation, enabling effective interaction with qubits for quantum computing or related applications. The separation of frequencies ensures compatibility with the qubit's operational requirements, enhancing system performance and control.

Furthermore, CW systems avoid the need for bulky optical delay lines and complex recombination optics often associated with pulsed laser setups, resulting in a more compact and mechanically stable design. While CW lasers may not support the ultra-fast gate speeds achievable with pulsed lasers, their operational simplicity, improved frequency control, and lower error rates make them a compelling choice when fidelity and stability are prioritized over speed.

In some aspects, the modulation stage 503 may include at least one of or a combination of an AM 503a, a FM/PM 503b, or an IQ modulator 503c to produce the desired SDK waveforms 504. The modulation stage 503 allows for precise pulse-to-pulse modulation, which is essential for suppressing multi-photon kicks. In some aspects, the modulation stage 503 is synched up to an external clock or with respect to another laser. In this way, the modulation stage 503 enables a level of control that ensures the creation of tailored waveforms that optimize performance and minimize unwanted diffraction artifacts.

In some aspects, the SDK waveforms 504 are sent through an amplification stage 505 and a wavelength conversion stage 507 to reach the desired wavelength and optical power. This process ensures that the SDK waveforms 504 are appropriately amplified and tailored to specific wavelength requirements, enabling them to meet the necessary operational parameters for optimal performance in the intended application.

A pulse-picking & direction stage 509 controls the timings and directions of the SDKs 506 applied to the ion 511. By precisely selecting and directing specific pulses (e.g., forward or backward), this stage ensures that the SDKs are accurately aligned with the target ion 511 at the appropriate intervals, enabling precise control and manipulation required for the intended operations.

To ensure coordinated operation across the system, electronic timing synchronization 513 aligns the modulation stage 503, amplification and wavelength conversion stages 505 and 507, and the pulse-picking and direction control stage 509. Specifically, it ensures that the frequency separation between the two CW laser outputs 502 matches the qubit frequency plus a tunable offset, which may be determined by an optimization routine. This precise frequency separation enables the combined optical fields to interact resonantly with the qubit states, allowing for controlled quantum operations.

Although CW lasers 501 emit continuously, timing synchronization remains essential. It ensures that modulation patterns (such as amplitude or phase modulation) are correctly timed with the control signals that determine when and how the optical field interacts with the ions quantum states and phase space locations. Without this synchronization, optical waveforms could be mistimed or distorted, leading to reduced gate fidelity. Overall, electronic timing synchronization maintains both frequency accuracy and temporal coherence, which are critical for high-precision, high-fidelity quantum gate execution.

The configuration in FIG. 5A offers several technical benefits by using a CW laser with pre-conversion modulation for generating high-fidelity SDKs in trapped ions. This approach simplifies system design by eliminating the need for tight pulse-level synchronization, reducing complexity and timing errors. Placing the modulation stage before wavelength conversion allows the use of high-speed NIR modulators, enabling precise amplitude and phase control to suppress multi-photon diffraction and optimize gate fidelity. The system also benefits from the CW laser's narrow linewidth and stable frequency output, which facilitates accurate qubit-resonant frequency separation. Overall, this architecture provides a compact, stable, and highly controllable platform optimized for fidelity and precision.

FIG. 5B illustrates a second example of generating optical waveforms for driving high fidelity SDKs in trapped ions using a CW laser in accordance with aspects of this disclosure. This configuration differs from the first example 500a shown in FIG. 5A, primarily in the positioning of the modulation stage within the optical path. Specifically, in example 500b, the modulation stage 503 is placed after the wavelength conversion stage 507, rather than before it as in the CW-based setup.

This change in architecture reflects a key adaptation to the different technical requirements of CW laser systems. By positioning the modulation stage after the wavelength conversion, the system directly modulates the pulses at the final wavelength that interacts with the trapped ions. This can offer advantages in eliminating potential distortions introduced during the nonlinear wavelength conversion process, which might otherwise degrade the carefully shaped waveform.

However, this configuration also imposes stringent demands on the modulators, which now need to operate efficiently at the physical wavelength (often in the visible range) where fewer commercial high-speed modulators are available. As a result, this approach is technically more challenging but may be necessary when precise waveform control must be preserved after conversion.

In summary, FIG. 5B demonstrates an alternative system architecture tailored to CW laser sources, where modulation is applied at the final interaction wavelength to ensure optimal waveform integrity and high-fidelity SDK performance in trapped-ion quantum gates.

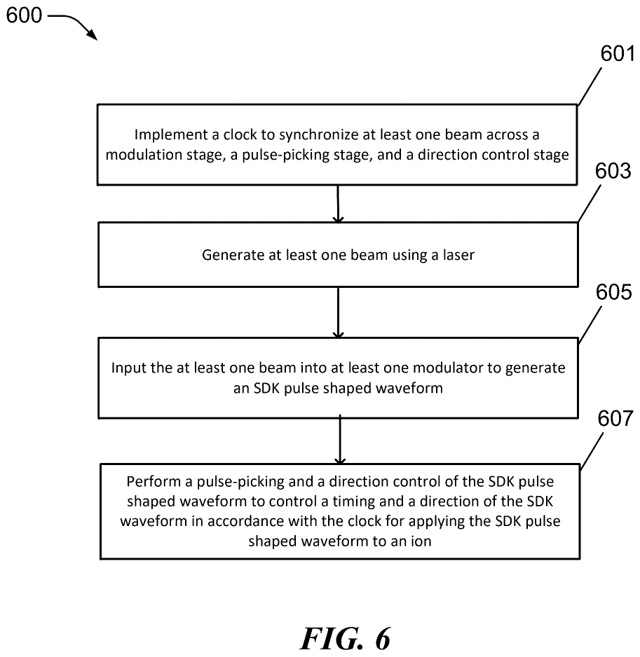

FIG. 6 illustrates an example of a method for generating optical waveforms for driving high-fidelity SDKs in trapped ions in accordance with aspects of this disclosure. The steps and algorithms described in relation to method 600 may be executed by processor 310 using algorithms component 210. In general, it is noted that the exemplary method 600 can be implemented using the components and systems described herein, especially with request to QIP system 200 and general controller 205 of FIG. 2 as described above and computing device 702 of FIG. 7 as described below. The steps and algorithms described in relation to method 600 may be executed by processor 310 using algorithms components 210. Specifically, the method 600 in FIG. 6 describes an overall flow process for generating optical waveforms for driving high-fidelity SDKs in trapped ions.

At 601, the method 600 may include implementing a clock to synchronize at least one beam across a modulation hardware component, a pulse-picking hardware component, and a direction control hardware component. This synchronization ensures precise timing and coordination among these processes, enabling seamless modulation, selective pulse extraction, and accurate beam direction control. The significance of this method lies in its ability to enhance system efficiency and reliability, reduce errors caused by misalignment, and improve overall performance in applications requiring high precision, such as advanced optical systems or laser-based technologies.

In some aspects, the modulation hardware component includes at least one modulator selected from an AM, a PM, a FM, or an IQ modulator, configured to shape the SDK pulse-shaped waveform on a per-pulse basis, the pulse-picking hardware component is configured to selectively transmit individual pulses of the SDK pulse-shaped waveform based on timing control signals derived from the clock, and the direction control hardware component is configured to route the selected pulses toward the first trapped ion in one of a plurality of optical paths.

At 603, the method 600 may include generating at least one beam using a laser. In some aspects, the laser should be a pulse-shaped laser that is shaped in a frequency and time domain in order to execute SDKs. This step is foundational as it provides the core energy source required for subsequent processes such as modulation, pulse picking, and directional control. The significance of this lies in the laser's ability to produce highly focused, coherent, and precise beams, which are essential for high-performance applications.

In some aspects, the at least one beam corresponds to a pulse train generated by a high-repetition rate pulsed laser. In some aspects, the high-repetition pulsed laser may correspond to: a NIR laser, a harmonically mode-locked laser, or soliton microcombs. As an example, referring back to FIG. 4Ad or 4B, the high-repetition rate pulsed laser 401 may generate a pulse train 402. This approach enables the system to produce a series of rapid and consistent pulses, which are key for processes requiring high temporal precision.

At 605, the method 600 may include inputting the at least one beam into at least one modulator to generate an SDK pulse-shaped waveform. The at least one modulator may be driven by the clock. The principle being that the SDK pulse-shaped waveform preserves the pulse-shaped engineered by the laser after the modulation stage. In other words, rather than significantly altering the pulse shape during modulation (as is typical in many traditional modulation schemes), the modulation process in this context is designed to maintain or minimally disturb the original pulse envelope or shape.

In some aspects, the at least one modulator corresponds to an amplitude modulator. As an example, referring back to FIG. 4A, the amplitude modulator 403a is configured to control the intensity of individual optical pulses within the high-repetition rate pulse train. The amplitude modulator 403a enables pulse-to-pulse modulation, allowing precise shaping of the optical waveform delivered to the ion. This modulation capability is important for suppressing undesired effects such as multi-photon diffraction and for ensuring that SDKs are applied with high fidelity. The use of amplitude modulation simplifies implementation while providing the necessary temporal resolution and control to support fast, high-fidelity multi-qubit gate operations in trapped ion systems

In some aspects, the at least one modulator corresponds to a frequency modulator. As an example, referring back to FIG. 4A, the FM/PM modulator 403b may be a frequency modulator configured to modulate the instantaneous frequency of each pulse within the high-repetition rate optical pulse train. By introducing a time-varying phase to the optical field, the frequency modulator enables dynamic control over the spectral content of the pulses. This modulation capability allows the system to tailor the frequency profile of each pulse to optimize its interaction with the ion qubits, for example, by suppressing off-resonant excitations or compensating for Doppler shifts or motional sideband effects. Frequency modulation can also be used in combination with amplitude and phase modulation to engineer complex SDK waveforms with high precision. The inclusion of a frequency modulator enhances the ability of the modulation stage to shape the optical pulses in both time and frequency domains, thereby improving the fidelity and robustness of fast, non-adiabatic multi-qubit gate operations.

In some aspects, the at least modulator corresponds to an IQ modulator. As an example, referring back to FIG. 4A, the IQ modulator 403c may be configured to provide simultaneous and independent control over the amplitude and phase of the optical pulses within the high-repetition rate pulse train. The IQ modulator 403c achieves this by modulating two orthogonal components of the input signal (e.g., the in-phase (I) and quadrature (Q) channels) enabling precise generation of complex optical waveforms. This dual-control functionality is particularly advantageous for tailoring the temporal and spectral characteristics of each pulse to suppress unwanted effects such as multi-photon diffraction and backward kicks, which can degrade the fidelity of SDKs. The IQ modulator 403c allows fine-grained, pulse-by-pulse customization of both intensity and phase, offering a flexible and compact solution for generating high-fidelity SDK waveforms. Its inclusion in the modulation stage facilitates the implementation of fast, scalable, and robust multi-qubit gate operations in trapped-ion quantum computing systems.

If a pulse laser is used, then the modulation should be performed synchronously with the laser pulses and the timing of the laser pulses has a very specific relation with the frequency of the qubit. Specifically, if the pulsed laser is used, then the modulation is performed synchronously with the laser pulses to ensure that each optical pulse is modulated with the intended control signal. The modulation timing is aligned such that the modulator is active only during the arrival of each pulse, preserving the integrity and fidelity of the modulated waveform. Furthermore, the timing of the laser pulses is configured to have a specific relationship with the frequency of the qubit, such that the pulse train constructively interacts with the qubit transition and the collective motional modes of the ions. This timing relationship is important for enabling coherent accumulation of phase and momentum necessary for high-fidelity SDKs. Synchronization may be achieved using a master timing source that drives both the pulsed laser and the modulator control electronics, ensuring phase coherence and deterministic modulation aligned with the quantum system dynamics.

If a CW laser is used, then the two CW beams may have frequencies separated by a qubit frequency and an offset. The magnitude of the offset may be determined by an optimization routine.

In some aspects, the method 600 may further include generating two CW beams using a CW laser, wherein the two CW beams have frequencies separated by a qubit frequency and an offset. In some aspects, the magnitude of the offset is determined by an optimization routine. As an example, referring back to FIG. 5A or 5B, the continuous wave laser 501 may generate two CW beam outputs 502 with the specified frequency separation derived from the same laser 501 or from phase-coherent laser sources and may possess respective frequencies that are separated by a frequency interval comprising a qubit frequency and an additional frequency offset. The qubit frequency may correspond to the energy difference between two quantum states of a qubit system, such as a trapped ion, superconducting circuit, or other quantum computing architecture. In certain embodiments, the magnitude of the frequency offset may be determined by an optimization routine configured to identify a parameter value that improves one or more performance metrics associated with qubit manipulation. Such metrics may include, but are not limited to, gate fidelity, error rate, coherence time, signal-to-noise ratio, or system stability. The optimization routine may be implemented using a classical control system, software-based feedback loop, or machine learning algorithm, and may involve scanning a range of offset values and selecting the value that yields optimal performance in a target quantum operation or sequence.

In some aspects, the method 600 may include modifying an optical power of the SDK pulse-shaped waveform for applying the SDK pulse-shaped waveform to apply fast gates on the ions. As an example, referring back to FIG. 4A, this modification is typically performed in an amplification stage 405 downstream of the modulation stage 403 and is necessary to ensure that the optical pulses have sufficient intensity to impart a strong and precise state-dependent momentum kick to the ions. The amplification step enables fast gate operations by delivering optical pulses with the power levels required to rapidly drive the desired quantum transitions while maintaining high fidelity.

In some aspects, the method 600 may include converting a wavelength of the SDK pulse-shaped waveform to a visible wavelength suitable for interaction with the specific atomic species used in the trapped ion system. As an example, referring back to FIG. 4A, this wavelength conversion 407 may be performed using nonlinear optical processes such as second harmonic generation (SHG), whereby a high-repetition rate pulsed laser 401 output is frequency-doubled to produce green or other visible wavelengths. This approach allows the use of high-performance modulators available at telecom or NIR wavelengths while still generating light at a wavelength that interacts efficiently with the target ion species. The combination of optical amplification and wavelength conversion enables high-speed, high-fidelity quantum gate operations while leveraging existing photonic technologies.

At 607, the method 600 may include performing a pulse-picking and a direction control of the SDK pulse-shaped waveform to control a timing and a direction of the SDK pulse-shaped waveform in accordance with the clock for applying the SDK pulse-shaped waveform to a first trapped ion in an ion trap. This process ensures precise timing and directional control of the waveform, synchronized with the clock, to apply it accurately to a first trapped ion in an ion trap. By selectively picking specific pulses and directing them with high precision, the method enables controlled interactions with the trapped ion.

It is understood that the method illustrated by FIG. 6 is exemplary in nature and that the steps described herein may be combined or modified to generate alternative embodiments.

FIG. 7 illustrates an example of a QIP system in accordance with aspects of this disclosure. The example QIP system 700 shown in FIG. 7 includes a control subsystem 710 that can receive a quantum program 704 from a computing device 702 that is remotely located relative to the example QIP system 700 and is functionally coupled (e.g., communicatively coupled) to the control subsystem 710. The computing device 702 can send data defining the quantum program 704 to control subsystem 710 for execution in quantum hardware 720, managing the modulation, amplification, conversion, and pulse-picking & direction, as described herein. As is indicated by dashed lines, the computing device 702 can be external to the example QIP system 700. For example, the computing device 702 can be a user device (e.g., a classical computer) of an end-user of the QIP system 700. The control subsystem 710 can retain the quantum program 704 in one or more memory devices 712. The quantum program 704 corresponds to a defined quantum computation. The defined quantum computation can be an n-qubit computation, for example. The quantum program 704 can include a quantum circuit (and, in some cases, sub-circuits, such as the modulation component, amplification component, wavelength conversion component, and/or pulse-picking component) representing a quantum algorithm associated with the quantum computation. Examples of the quantum algorithm include a variational quantum algorithm, a machine-learning algorithm, a Fourier transform algorithm, or the like.

The control subsystem 710 can be functionally coupled to quantum hardware 720 via multiple links 714 that permits the exchange of data and/or controls signal between the control subsystem 710 and the quantum hardware 720. The quantum hardware 720 can embody or can include one or more quantum computers. In some cases, the quantum hardware 720 embodies a cloud-based quantum computer. In other cases, the quantum hardware 720 embodies, or includes a local quantum computer. Regardless of its spatial footprint, the quantum hardware 720 includes multiple qubits 730 arranged in a particular layout. Each qubit of the qubits 730 (including the target and ancilla qubits described herein) can be coupled to an environment and/or to one another. Such coupling(s) decoheres and relaxes quantum information contained in the qubit. Thus, the quantum hardware 720 can be noisy. The type of the multiple links can be based on the type of qubits 730 used by the quantum hardware 720 for computation. In some cases, the multiple links 714 can include wireline links or optical links, or a combination of both. In other cases, the multiple links 714 can include microwave resonator devices or microwave transmission lines, or a combination of both.

The qubits 730 can include atomic qubits assembled in an atom-trap. Thus, the atomic qubits can be referred to as trapped-atom qubits. In some cases, each one of the atomic qubits can be a neutral atom. In other cases, each one of the atomic qubits can be an ion, such as an Ytterbium ion, a calcium ion, or similar ions. The atomic-qubits in such cases can be confined within an ion-trap (e.g., the trap 270 (FIG. 2) and can be assembled in a linear arrangement (such as the linear crystal or chain 70 (FIG. 1)). In other implementations, the qubits 730 can include solid-state devices of one of several types. Such devices can be embodied in, for example, Josephson junction devices, semiconductor quantum-dots, or defects in a semiconductor material (such as vacancies in Si and Ge, or nitrogen-vacancy centers in diamond).

The control subsystem 710 can cause the quantum hardware 720 to execute the quantum circuit and/or sub-circuits as described herein. In response, the control subsystem 710 can receive measurement data 718 indicative of computation outputs that includes the pulse-picking and direction control of the SDK pulse-shaped waveform, for example. Because the quantum computation can be performed in two or more qubits, a measurement outcome can be represented as a bitstring representing a particular target output state given a particular set of qubits involved in a quantum computation. The control subsystem 710 can supply at least a portion of the measurement data 718 to components of the control subsystem 710 and/or other subsystems (e.g., post-processing subsystem 750).

The control subsystem 710 also can be functionally coupled to a post-processing subsystem 750 via a communication architecture 740. The communication architecture 740 can include wirelines links, wireless links, network devices (such as gateway devices, servers, and the like), or a combination thereof. The post-processing subsystem 750 can apply one or several post-processing techniques to measurement data 718 received from the quantum hardware 720. By applying such techniques, the post-processing subsystem 750 can generate a result 754 of a quantum computation executed by the quantum hardware. The post-processing subsystem 750 can send the result 754 (or data indicative of the result 754) to the computing device 702 and/or other computing device(s) 758. The post-processing subsystem 750 also can cause the computing device 702 to present the result 754 in a particular way. For example, the post-processing subsystem 750 can direct the computing device 702 to present a user interface including the result 754.

As an example, the method 600 for generating optical waveforms for driving high-fidelity SDKs in trapped ions, as described in FIG. 6, may be implemented within the architecture illustrated in FIG. 7. The step of implementing a clock to synchronize the modulation, pulse-picking, and direction control stages is reflected in the control subsystem 710, which orchestrates precise timing across hardware components. The generation of at least one beam using a laser is encompassed within the quantum hardware 720, which includes laser sources and ion traps. The step of inputting the beam into a modulator to produce an SDK pulse-shaped waveform, with the modulator driven by the clock, may be managed by the control subsystem 710, which ensures the modulation process preserves the engineered pulse shape from the laser. Finally, the actions of pulse-picking and direction control to regulate the timing and direction of the waveform (also synchronized by the clock) are directed by the control subsystem 710 and applied to the ion 730 via the quantum hardware 720. Thus, FIG. 7 illustrates how the claimed method is implemented in a complete system where programmatic control, precise timing, and optical delivery are integrated to apply SDKs to trapped ions.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

In general, it is noted that the foregoing description of the disclosure is provided to enable a person skilled in the art to make or use the disclosure. Various modifications to the disclosure will be readily apparent to those skilled in the art, and the common principles defined herein may be applied to other variations without departing from the scope of the disclosure. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise. Thus, the disclosure is not to be limited to the examples and designs described herein but is to be accorded the widest scope consistent with the principles and novel features disclosed herein.

What is claimed is:

1. A method for generating optical waveforms for driving state-dependent kicks (SDKs) in trapped ions, the method comprising:
implementing a clock to synchronize at least one beam across a modulation hardware component, a pulse-picking hardware component, and a direction control hardware component;
generating the at least one beam using a laser;
inputting the at least one beam into at least one modulator to generate an SDK pulse-shaped waveform, wherein the at least one modulator is driven by the clock; and
performing a pulse-picking and a direction control of the SDK pulse-shaped waveform to control a timing and a direction of the SDK pulse-shaped waveform in accordance with the clock for applying the SDK pulse-shaped waveform to a first trapped ion in an ion trap.

2. The method of claim 1, wherein the at least one beam corresponds to a pulse train generated by a high-repetition rate pulsed laser.

3. The method of claim 2, wherein the high-repetition pulsed laser corresponds to: a near infrared (NIR) laser, a harmonically mode-locked laser, and soliton microcombs.

4. The method of claim 1, further comprising:
generating two continuous wave (CW) beams using a CW laser, wherein the two CW beams have frequencies separated by a qubit frequency and an offset.

5. The method of claim 1, wherein the at least one modulator corresponds to an amplitude modulator (AM).

6. The method of claim 1, wherein the at least one modulator corresponds to a frequency modulator (FM).

7. The method of claim 1, wherein the at least one modulator corresponds to a phase modulator (PM).

8. The method of claim 1, wherein the at least one modulator corresponds to an in-phase and quadrature (IQ) modulator.

9. The method of claim 1, further comprising:
modifying an optical power of the SDK pulse-shaped waveform for applying the SDK pulse-shaped waveform to apply fast gates on the ions.

10. The method of claim 9, further comprising:
converting a wavelength of the SDK pulse-shaped waveform to a visible wavelength.

11. The method of claim 1, wherein the modulation hardware component comprises at least one modulator selected from an AM, a PM, a FM, or an IQ modulator, configured to shape the SDK pulse-shaped waveform on a per-pulse basis, the pulse-picking hardware component is configured to selectively transmit individual pulses of the SDK pulse-shaped waveform based on timing control signals derived from the clock, and the direction control hardware component is configured to route the selected pulses toward the first trapped ion in one of a plurality of optical paths.

12. A quantum information processing (QIP) system for generating optical waveforms for driving state-dependent kicks (SDKs) in trapped ions, comprising:
an array of trapped ions including a first trapped ion;
an optical system configured to generate at least one beam;
an ion trap configured to trap the first trapped ion, a trapping potential of the ion trap being switchable between a first trapping potential and a second trapping potential; and
a controller configured to control operations of the optical system and the ion trap, the controller configured to:
implement a clock to synchronize at least one beam across a modulation hardware component, a pulse-picking hardware component, and a direction control hardware component;
cause the optical system to generate the at least one beam;
input the at least one beam into at least one modulator to generate an SDK pulse-shaped waveform, wherein the at least one modulator is driven by the clock; and
perform a pulse-picking and a direction control of the SDK pulse-shaped waveform to control a timing and a direction of the SDK pulse-shaped waveform in accordance with the clock for applying the SDK pulse-shaped waveform to the first trapped ion in an ion trap.

13. The QIP system of claim 12, wherein the at least one beam corresponds to a pulse train generated by a high-repetition rate pulsed laser.

14. The QIP system of claim 13, wherein the high-repetition pulsed laser corresponds to: a near infrared (NIR) laser, a harmonically mode-locked laser, and soliton microcombs.

15. The QIP system of claim 12, wherein the controller is further configured to generate two continuous wave (CW) beams using a CW laser to control operations of the optical system and the ion trap, wherein the two CW beams have frequencies separated by a qubit frequency and an offset.

16. The QIP system of claim 12, wherein the at least one modulator comprises to an amplitude modulator (AM).

17. The QIP system of claim 12, wherein the at least one modulator comprises to a frequency modulator (FM).

18. The QIP system of claim 12, wherein the at least one modulator comprises to a phase modulator (PM).

19. The QIP system of claim 12, wherein the at least one modulator comprises to an in-phase and quadrature (IQ) modulator.

20. The QIP system of claim 12, wherein the controller is further configured to modify an optical power of the SDK pulse-shaped waveform for applying the SDK pulse-shaped waveform to apply fast gates on the ions.
